(19) United States
(12) Patent Application Publication
(10) Pub. No.: US 2006/0129590 A1
(43) Pub. Date: Jun. 15, 2006

(54) Method and medium for managing data

(75) Inventors: Edwin Marion Brown, Los Angeles, CA (US); James Edward Rice, Los Angeles, CA (US)

Correspondence Address: MORRISON & FOERSTER, LLP, 555 WEST FIFTH STREET, SUITE 3500, LOS ANGELES, CA, 90013-1024, US

(73) Assignee: Aoki-Rice Companies, Los Angeles, CA (US)

(21) Appl. No.: 11/009,902

(22) Filed: Dec. 10, 2004

(51) Int. Cl. G06F 17/00

(52) U.S. Cl. 707/102

(57) ABSTRACT

The present invention allows a user to create an application to manage a database without writing code. The present invention includes a method of creating a database, creating configuration data relating to the data in the database and generating a user interface based on the configuration data to allow a user to search, select or edit the data. The configuration data includes defining fields, search parameters, page layout and relationships between data. A component reads the configuration data to generate the interface elements and performs the actions executed by the user through the interface.

### BACKGROUND OF THE INVENTION

The present invention relates to managing data and more particularly to a method and medium for managing data in a database. The method or the medium in a computer allows a user to search, select or edit data in a database without writing any software code.

The advent of the personal computer, the development of the Internet and advances in computer-related technology have resulted in a dramatic increase in the amount of information created on a daily basis. Indeed, our age is sometimes referred to as the Information Age. With the increase in the amount of information, there has developed a need by businesses, governments, organizations and individuals to store information and, then, manage the stored information.

Storage of information is typically done electronically. Data representing information can be stored in electronic databases. These databases may reside in a portion of the memory of a personal computer or server. The portion of the memory is both readable in order for the data in the database to be accessed and writable for data to be added, deleted or otherwise modified. Data in the database is organized into tables. Each table comprises one or a plurality of records. A record is a related group of data composed of field types (also known as fields). The record can have one field type of data, such as the name of an individual, or several field types such as the name and telephone number of an individual. For example, a “Tax” database can have a table (entitled “Taxpayer Table”) having records of taxpayers with three fields: a first name field, a last name field and an address field (i.e., alpha-numeric). Another table in the “Tax” database—perhaps entitled “Payment Table”—can have payment records with two fields: an amount of payment field and a date of payment field.

It is not sufficient to simply store data in a database. The Information Age requires that data be easily displayed, searched, selected, edited and linked with other data. Such management of data is achieved by hiring a software developer to develop a software application. The software developer initially must spend considerable time understanding the database belonging to a business, government, organization or individual. Then, the software developer must spend some additional time explaining to his or her employer what he or she intends to create. After obtaining approval, the software developer typically develops the software by working at the field level. These means that he or she creates a form with one or more fields and then adds labels for each field on the form. For example, in the Tax database discussed above, the software developer may develop several webpages. He or she may write code in HTML to create a first form (entitled “Taypayer Form”) having the first name field, the last name field and the address field. The form may have labels “First Name”, “Last Name” and “Address” corresponding to the respective fields. The software developer may develop a second form (entitled “Payment Form”) having the fields and labels related to payment, i.e., an amount of payment field and its corresponding label and a date of payment field and its corresponding label.

There are tools or applications that allow the software developer to link the created forms (such as Taxpayer Form and Payment Form) to tables in the database (such as Taxpayer Table and Payment Table). For example, the tools allow the Taxpayer Form to have a first record button, a previous record button, next record and a last record button. The user can use the buttons to advance between the various records in the Taxpayer Table.

However, these tools only provide rudimentary navigational abilities. Advanced navigational abilities require the software developer to write further code. For example, if the organization wants to search the Taxpayer Table as opposed to manually advancing page by page, it must request that the software developer develop further code. The developer must develop a search form and write code that (1) links the search form to the Taxpayer Form and the Taxpayer Table and (2) analyzes the search results. If the organization wishes to display related data, such as the data in the Taxpayer Table with the data in the Payment Table, it must further request that the software developer write additional code. If the organization requests that a field in a given form be populated with a list, it must further request that the software developer write additional code.

Accordingly, to manage data in a database with advanced navigational abilities, a business, government, organization or individual must find and hire an experienced software developer to develop the application. Once hired, the business must wait for the software developer to understand the database and the desired navigational abilities and then write the lengthy code. Once the code is developed, it must be tested by the software developer to ensure that it achieves the desired navigational abilities. In short, a business, government, organization or individual who desires to manage data in a database with advanced navigational abilities must expend a tremendous amount of resources and time to develop a software application.

### BRIEF SUMMARY OF THE INVENTION

The present invention allows a non-programmer to create a complete working application to manage a database without writing a single line of code. The application provides advanced functionality, including complex search and drill down, the ability to open multiple windows simultaneously and navigate between them, targeted help files and login capability.

The present invention comprises creating a database, creating configuration data relating to the data in the database and generating a user interface based on the configuration data to allow a user to search, select or edit the data.

To create configuration data, the user employs a program having one or more user interfaces. The user navigates the interface(s) or pages of a single interface as desired to define the configuration data. The configuration data includes defining fields, selecting fields for search, defining how those fields are searched, selecting fields to be “select list” fields and defining the data for the list, defining the page layout for the user interface to manage the database, establishing the relationship between tables, providing security and defining form information for the user interface. Because the user can define such information through easy-to-use interfaces, there is no need for the user to be a skilled programmer.

Once the configuration data is created, the user through the main application program can activate a form for managing the database. The form is a component that automatically reads the configuration data and generates an interface that allows the user to search, select or edit the data of the database. The form reads the configuration data to generate the tabs, buttons and so on, to create the components of the search, select and edit pages and to populate the select lists corresponding to select fields. The form then awaits the user's command to perform the desired actions. Once the user provides a command through the interface, the form executes the command.

The present invention provides numerous advantages. The working application can be developed by non-programmers or by people with limited programming experience, such as domain experts, skilled interviewers and business analysts. Such people are normally less expensive than programmers. Moreover, such individuals can be recruited from the organization for which the application is used. This minimizes costs, because the individual knows more about the organization than an outside programmer.

Another advantage of the present invention is that it reduces the time to develop the application, both in calendar time and labor hours.

Another advantage of the present invention is that it reduces testing time, because the application needs only to be tested for screen layout and template consistency.

While the present invention provides enough functionality for most database management projects, the present invention also easily allows the user to add further features.

These and other features and advantages of embodiments of the present invention will be apparent to those skilled in the art from the following detailed description of the embodiments of the invention, when read with the drawings and the appended claims.

### BRIEF DESCRIPTION OF THE DRAWINGS

FIG. 1 is a block diagram of a computer for implementing the present invention.

FIG. 2 is a flowchart illustrating a sequence of operation of the present invention.

FIG. 3 is a flowchart illustrating a sequence of operation for creating a database.

FIG. 4. is a flowchart illustrating a sequence of operation for creating configuration data.

FIGS. 5-16 are graphical user interfaces displayed in the process of creating configuration data.

FIGS. 17 and 18 are flowcharts illustrating a sequence of operation for generating a user interface having search, select and edit capabilities.

FIGS. 19-22 are graphical user interfaces displayed in the process of generating a user interface.

### DETAILED DESCRIPTION OF THE INVENTION

In the following description of embodiments, reference is made to accompanying drawings which form a part hereof and in which is shown by way of illustration specific embodiments in which the invention may be practiced. It is to be understood that other embodiments may be utilized and structural changes may be made without departing from the scope of the preferred embodiments of the present invention.

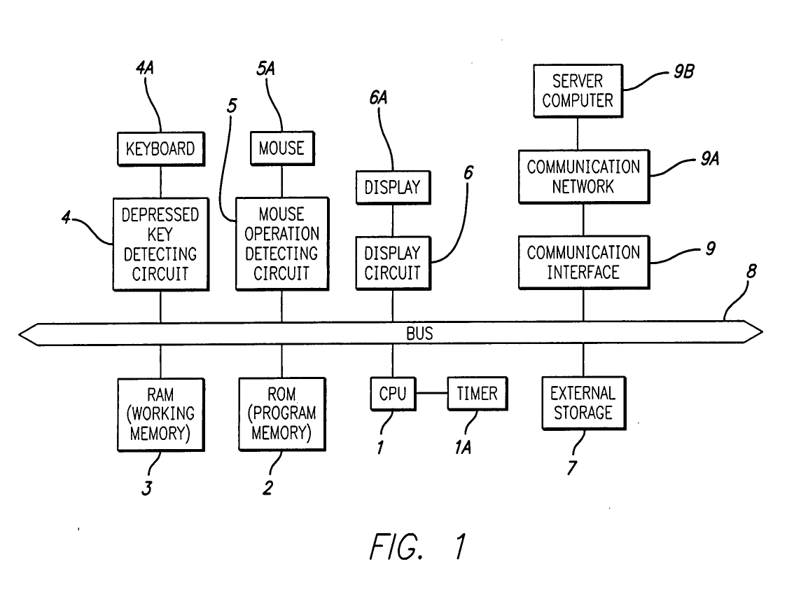

The present invention can be implemented by an apparatus such as a computer. FIG. 1 is a block diagram of the major components of a computer. The computer comprises a microprocessor unit (CPU) 1. The CPU 1 controls the entire operations of the computer. The CPU 1 is connected to a timer 1A for counting various time periods, which may be necessary in order for the CPU 1 to perform certain operations. The CPU 1 is connected to the other components of the computer via a data and address bus 8.

One such component is the program memory 2. Program memory 2 is a read-only memory (ROM). The program memory 2 can store various programs and data. For example, an operating system (OS), which manages the operations of the computer, may reside in the program memory. The working memory 3 is a random access memory (RAM). It is used to temporarily store information and data generated as the CPU 1 executes programs.

The CPU 1 connects to the keyboard 4A via a key detecting circuit 4. The keyboard 4A may have various operators for inputting information, such as letter keys and a ten-button keypad for numerical data entry. When a given operator is depressed, the key detecting circuit 4 detects the depression and outputs information representing the detection to the CPU I via bus 8.

Mouse 5A is used in connection with display 6A. A user manipulates the mouse 5A to point to various items on the display 6A and then gives instructions to perform an action. For example, moving the mouse 5A to an icon of a program on the display 6A and then double-clicking the mouse 5A launches the program. The mouse operation detecting circuit 5 constantly detects the operating state of mouse 5A. When the mouse 5A is clicked to launch the program, the mouse operation detecting circuit 5A supplies information regarding the clicked state of the mouse to the CPU 1 via bus 8. Other than the mouse pointer, the display circuit 6 displays various information on the display 6A. The display 6A may be an LCD device or a CRT device as is well known.

The external storage device 7 is provided for storing data and programs for execution by the CPU 1. It should be noted that the external storage device 7 is not limited to storing data of databases. The storage device 7 may store a program or programs. The CPU 2 can read such programs from the external storage device 7 into the RAM 3 and perform instructions in the same manner as if the programs where stored in the working memory 2. The external storage device 7 may be a hard disk or various removable-type media such as a floppy disk, a compact disk (CD-ROM or CD-RAM), a magneto-optical disk or a DVD.

The communication interface 9 is connected to a communication network 9A. The communication network 9A can be, without limitation, a local area network (LAN), the Internet or telephone lines. The communication network 9A is, in turn, connected to a server computer 9B. The server computer 9B can store various programs. The communication interface 9 and the communication network 9A thereby allow the computer to be connected to a server computer 9B and receive programs that are not stored in the working memory 2 or the external storage device 7.

The present invention can be implemented as a series of instructions that can reside in a medium or program storage device such as program memory 2 or external storage device 7. The instructions are collectively known as a program. The present invention is implemented through two programs defined herein as a configuration application program and a main application program. It should be noted that the present invention can also be implemented in a single program. Thus, while the description of the present invention may refer to plural programs, such statements should not be construed as limiting the present invention to a given number of programs.

Furthermore, the present invention can be implemented for the benefit of any business, organization, government or individual. As an example, the following discussion will describe the present invention implemented for the benefit of a non-profit organization working to reduce teen pregnancy and infant mortality.

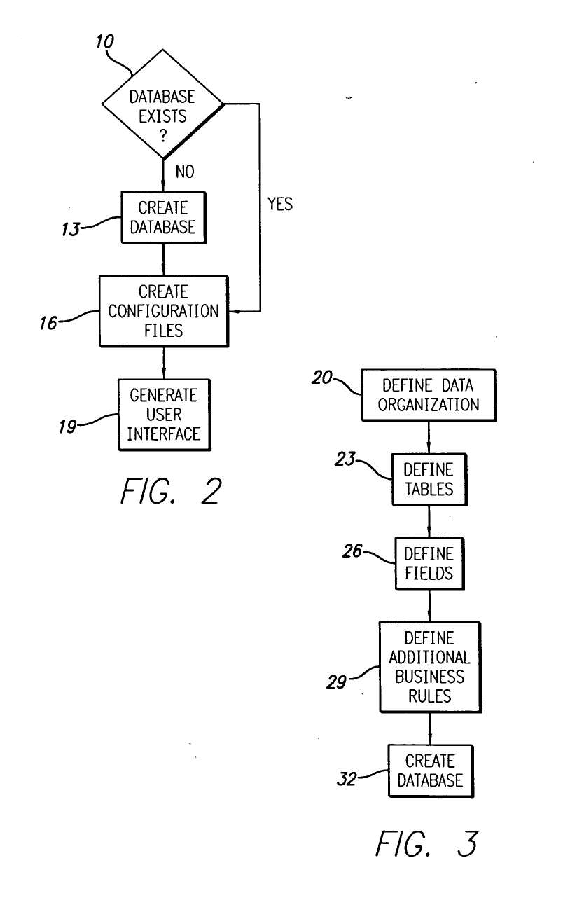

The operation sequence of the present invention is shown in FIG. 2. The sequence may be automated, but typically the sequence of steps will be overseen by a user, such as an employee of the non-profit organization. The user does not have to be a skilled software developer, because the present invention allows data to be managed without writing any code.

The first step 10 in FIG. 2 is to determine whether a database for storing the data to be managed exists. If a database already exits, the sequence proceeds directly to step 16. If a database does not exist, the sequence proceeds to step 13. At step 13, a database is created. FIG. 3, discussed below, sets forth the steps for creating a database. Once a database is created or it is determined that the database already exists, the sequence proceeds to step 16.

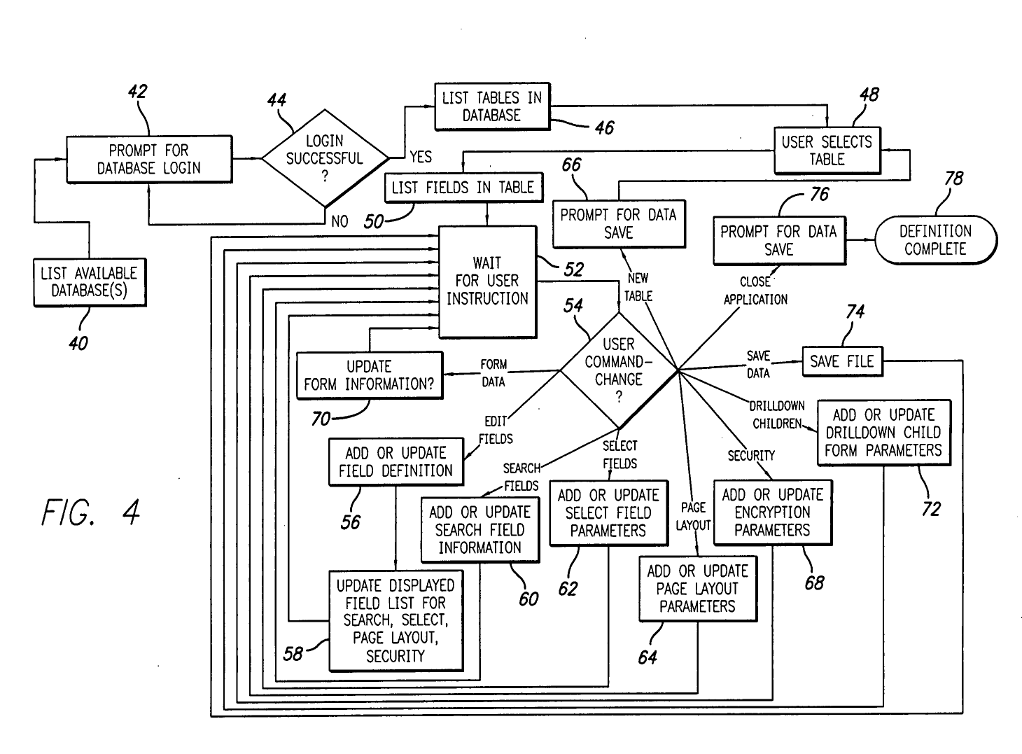

At step 16, configuration data is created using the database. The configuration data can be generated manually, but the present invention includes a configuration application program for generating the configuration data. The sequence of steps performed by this program is discussed below in connection with FIG. 4. The configuration data describes the relationships between the types of information to be stored. For example, in the case of the non-profit organization referred to above, a teen may enter a program on a given day. The information provided at the intake interview, such as intake date and referral source, may be stored in an intake table. The outcome of the teen's pregnancy may be stored in another table. The configuration data may indicate that the intake table is a master table, while the pregnancy outcome table is a subsidiary or child table to the intake table.

Aside from defining the relationships between the types of information stored, the configuration data defines information regarding the fields in a given table. The configuration data may include field names, captions, data types (integer, currency, text, date, etc.), handling of data input errors and size of the space made available to the user for editing. Some fields can be marked as read-only, thereby prohibiting a user from editing them. How the data is defined will be reflected in the user interface subsequently created.

The user has complete discretion in determining the number of relationships and information to define and, thus, how much configuration data to generate. The user can eliminate some of the relationships between tables or limit the amount of information he defines to provide an easier-to-use application albeit with reduced functionality.

The preferred means of organizing and storing the configuration data is to have one file per application screen and to store the configuration data as operating system data files. For example, step 16 of FIG. 2 may generate a number of XML (extensible markup language) files corresponding to the number of application screens. It should be noted that other organizing and storage means are within the scope of the invention. Such other organizing and storage means include a single file for all the configuration data, more than one file per table, collecting types of information in separate files independent of the table to which they apply and storing the configuration data in a database.

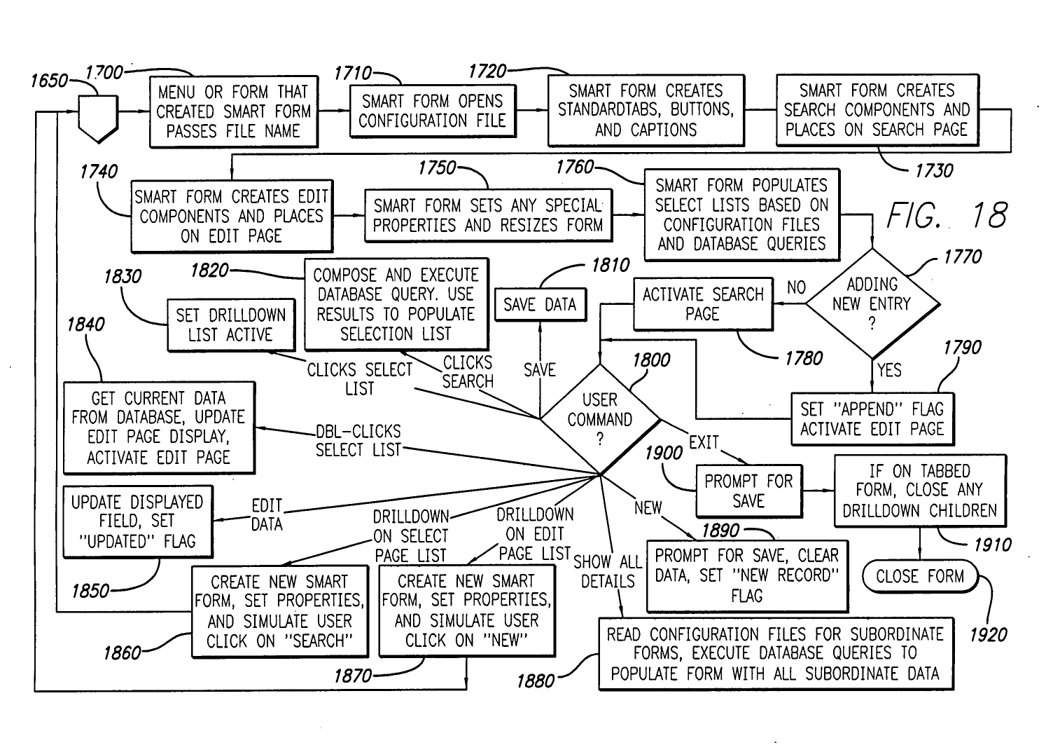

Once the configuration data is organized and stored, the main application program (discussed below in conjunction with FIGS. 17-22) generates a user interface based on the configuration data as indicated by step 19 of FIG. 2. The user interface is presented to the user as a graphical user interface (GUI) that allows the user to manage the data of the database. The interface allows the user to search the database, select data in the database or edit the database. That is, the user can do all three tasks (select, search, edit), two of the tasks or just one task depending on what he needs to do. Preferably, each of these tasks is on a page with a respective tab entitled “Search,” “Select,” or “Edit” to allow the user to quickly move among the tasks. Other forms of display include separate pages for each task or having the tasks in different sections of one page or window.

Once a user clicks on the “Search” tab, he can enter information to be searched. In the example of the non-profit organization, an intake form corresponding to the intake table may be generated that allows the user to search based on an intake date. The user can thus input a given intake date to search. The “Select” tab allows the user to select a record or the records that match the search criteria. If master-child relationships were defined in step 16, the user is also presented with the child tables relating to the master intake table. The user can then select one or more child tables. The “Edit” tab presents all the elements in the intake form for display and editing. Preferably, if data is edited, it will be compared against the field type before saving the edit. This is to prevent the user from accidentally entering incorrect data in a field (e.g., a letter in a date field). Such a check can be defined by the configuration data created in step 16. While editing typically refers to modifying the data in some way, the present invention can also be implemented such that certain tables or portions thereof are for display only and preclude editing.

The operation sequence in FIG. 2 can be repeated a number of times to demonstrate that the database can be managed. The user, for example, may demonstrate to his employer or his client its functionality. Moreover, if desired, other features can be added. For example, the user may wish to implement non-standard features and business rules. He may further desire to assist other users by using the configuration application program to add “Help” to the XML files.

The present invention is not limited to the sequence set forth in FIG. 2. While it is preferred to first generate a database (step 13) and then generate configuration data (step 16) to match the database, other sequences can be used. The configuration data can be generated without access to the database or before the database existed. That is, FIG. 2 can be modified by having configuration data generation (step 16) precede the database generation (step 13). An application would then read the configuration data and automatically create a database by generating database tables.

This application would, for example, comprise a series of SQL (structured query language) database creation scripts. The exact syntax varies slightly by database. For example, for Postgresq1, the script would be of the form:

Create Database<table>(

id serial not null primary key,

<first field name><first field data type,

<second field name><second field data type),

. . .

)

For each of the parent and child relationships, the application would modify the child field creation line to form:

<field name>integer references<parent table>

For each of the child database tables, the application would create an index to enhance database performance. These would be of the form:

Create index <child table name>_<field>on<child table name>(field);

The application would then execute each of these scripts, thereby creating the database.

FIGS. 3-22 provide further detail for each of the steps in FIG. 2.

A. Creating A Database

If a database does not exist, it is created at step 13 of FIG. 2. FIG. 3 sets forth the steps of creating a database. The user preferably uses a language such as SQL to create the database. As a preliminary step (step 20), the user should define the organization of the data. This will require the user to understand the type of data that will be stored in the database and how different types of data relate. At step 23, the user defines the tables that are needed. In the example of the non-profit organization, the user can define an intake table, a pregnancy outcome table, a drug use table, a visit table and so on. Each of these tables will store records pertaining to the subject of the table. At step 26, the user defines the fields as needed for each table defined in step 23. Defining the fields includes establishing the types of fields and their respective sizes in any given table.

The sequence proceeds to step 29 where the user defines additional business rules if necessary. The term “business rules” describes rules important to how an organization functions, as they apply to data stored in a database. They are implemented in several ways depending on the type of rule. The first type of rule is information consistency, i.e., the data taken individually makes sense. An example of such a rule is that every client must have an ID. Another example is no two employees can have the same login. Information consistency rules are normally implemented as requirements in the database at the field or table level. That is, the database is created such that it will not accept values which violate one of these rules.

The second type is information compliance, i.e., the information in one table is consistent with the information in the rest of the database and also in accordance with rules of operation. An example is that a client record cannot be deleted if the client has made a purchase. Another example is to keep the last three telephone numbers and addresses of a client. Information compliance rules are usually implemented inside the database, but they require the use of database functions and triggers. Triggers and functions are small software applications that execute inside the database.

The third type of rule is process or operational rules. These rules are usually more complex. They involve more than the information itself, such as the process through which the information is developed, changed or viewed. An example of this type of rule is that any purchase over $5000 must be reviewed by a manager. Another example is that only managers at level 5 or above can initiate a request to hire an employee. These rules can be implemented inside the database in the manner of information compliance rules, but they typically involve some programming in the application, outside the database.

Referring back to FIG. 3, step 29 of defining additional business rules is followed by the creation of the database at step 32. Creating the database involves creating top-level database tables, creating procedures and creating triggers to implement business rules. Creating top-level database tables begins by creating a first top-level database with indices. Indices are created by the database developer to tell the database engine to analyze tables for later searching. Then, it is determined whether there is a subordinate table to be created. If there is no subordinate table to be created, the program returns to creating another top-level database. If a subordinate table needs to be created, it is created with indices in the same manner as the top-level table. Thereafter, it is determined whether there is another subordinate table to be created. If there is, the program returns to create another subordinate table. The process is repeated until all subordinate tables are created. If there are no more subordinate tables to be created, the program returns to create another top-level database table. This process is repeated until all top-level database tables are created. Creating the database also involves creating procedures and triggers to implement business rules. These are created until no more procedures and triggers are needed.

B. Creating Configuration Data

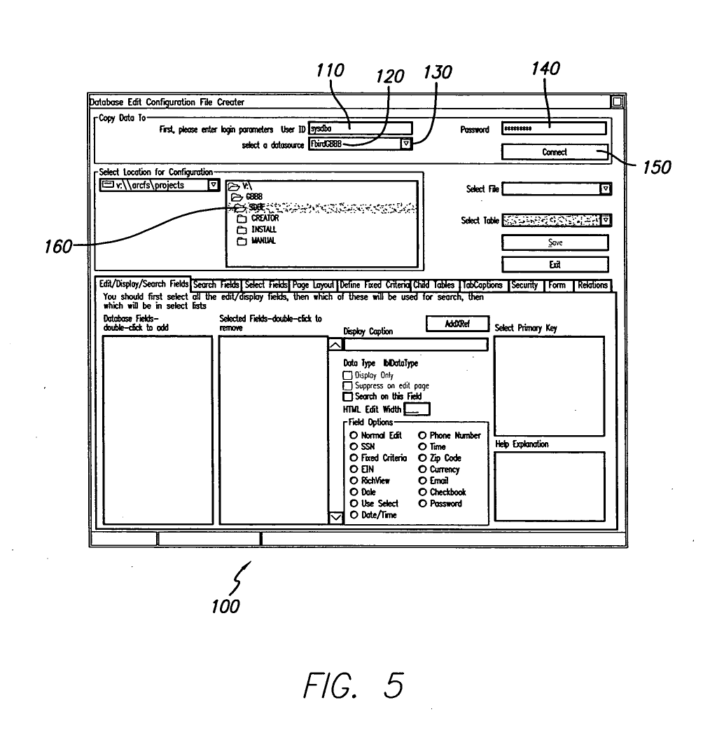

FIG. 4 illustrates the steps or instructions of the configuration application program that allows a computer to create or generate configuration data illustrated at step 16 in FIG. 2. As discussed above, the configuration data is used to generate the user interfaces for managing data and establish relationships between the types of information stored. The application program of FIG. 4 provides a series of navigable user interfaces illustrated in FIGS. 5-16 that allow the user to select the formats or parameters and relationships for managing data. Because what the user selects will define the configuration data, the steps or instructions of the application program in FIG. 4 are dependent in part on user input. Accordingly, the following discussion will refer to FIG. 4 in conjunction with each of FIGS. 5-16. It should be noted that FIGS. 5-16 share some of the same elements and that some of these shared elements are not re-numbered in each figure.

The application program can be opened by having the user select an icon of the program on display 6A. Once selected, the application program first instructs the computer to provide the user with a list of available databases at 40 of FIG. 4. The list of available databases may include already existing databases as well as databases created at step 13 of FIG. 2. As illustrated in FIG. 5, the user is presented with a graphical user interface 100 on display 6A. The interface 100 provides the list of databases though a drop-down list to the user, where he can select a database 120. Once he selects a database, the program prompts the user for his login parameters at 42 of FIG. 4. The user enters his login parameters (e.g., ID and password) in boxes 110 and 140 of FIG. 5 and then presses connect key 150 using mouse 5A. If the login is successful at 44 of FIG. 4, the user selects a folder 160 in FIG. 5 where the configuration data will be stored as a file or files. If the login is not successful, the user is prompted once again for his login parameters.

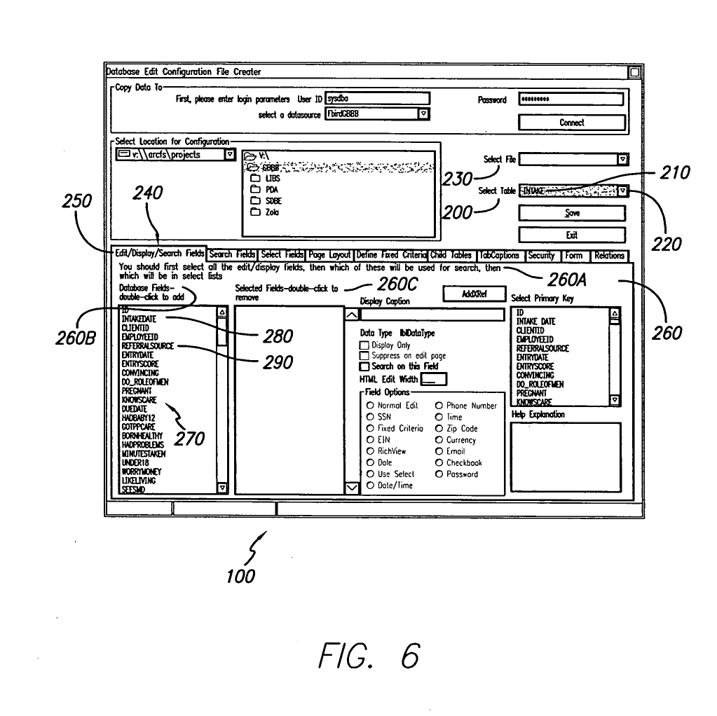

Once the login is successful and the user has selected a folder for storing the configuration data, the program instructs the computer to list the tables in the database at 46. The tables are listed for selection at 48. FIG. 6 illustrates how the tables are listed and how the user makes the selection. The interface 100 has a “Select Table” caption 200 corresponding to a drop down list box 220. The drop down list box 220 provides the name of all the tables in the database. In the example of the non-profit organization, the user has selected the INTAKE table 210. The user can provide or select, at 230, a file name for the created configuration file. Typically, the file name is the same as the table name.

The program then instructs the computer to list all the available fields for the selected table at 50 of FIG. 4. This is illustrated in the lower half of interface 100 in FIG. 6. The lower half is bordered by a series of tabs 240. When a given tab, such as “Edit/Display/Search Fields” 250, is selected, a portion 260 corresponding to the tab is displayed. The portion 260 displays information 260A helpful to the user as well as headings 260B and 260C. Heading 260B identifies the box as the list of available fields 270 for the selected table. Two of the fields are INTAKEDATE 280 and REFERRALSOURCE 290.

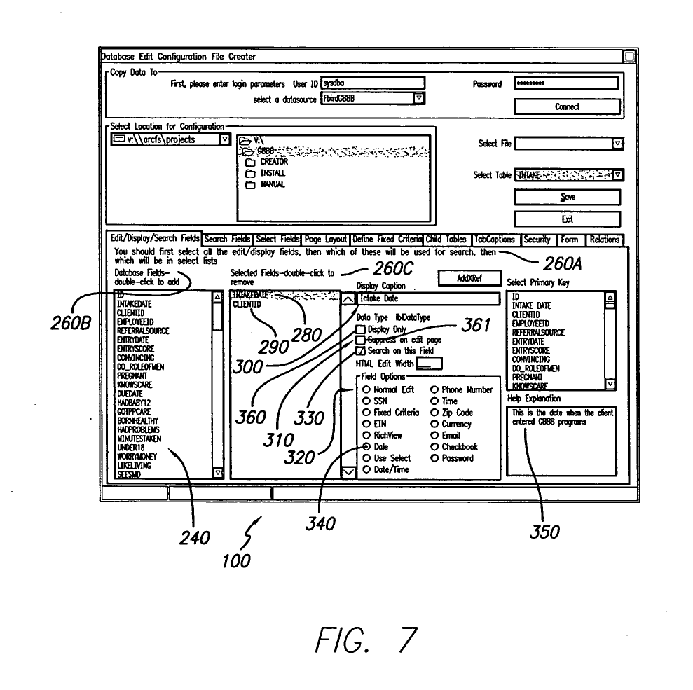

The program then awaits a user instruction at 52 through a user command 54. Once a command is made, the program instructs the computer to perform an operation in accordance with the command. As FIG. 4 illustrates, there are many commands for the user to choose. He may select one command, some commands or all the commands. One command 56 is to edit the fields for the table. As illustrated in FIG. 7, the user has selected two fields—INTAKEDATE 280 and REFERRALSOURCE 290—to edit by double clicking these fields in the box under heading 260B. The two fields 280 and 290 are then placed in the box under heading 260C entitled “Selected Fields.” The user, in FIG. 7, has currently selected INTAKEDATE 280 for editing as shown by the highlighting. The program allows the user to edit the field in a number of ways.

At 300, the user can provide the name of the caption for the field. Here the field INTAKEDATE will be displayed with the caption relating to intake date. At 310, the user can further edit the field by defining it as a search field 330. This means that this field will be displayed on the search page of the generated user interface when the main application program is executed. The “Suppress on edit page” box 361, if checked, will display the field on the search page, but not on the edit page of the generated user interface. The “Display Only” box 360, if checked, would allow the user to see the data, but not edit it.

Editing includes adding or updating a field definition. At 320, the user can edit the data type. This tells the main application program to validate the data at entry. FIG. 7 illustrates the user has made the INTAKEDATE field a date field 340.

In this manner, the user can create the configuration data necessary to create a user interface that has a caption relating to intake data, with a corresponding data field through which searches can be generated.

It should be noted that the interface 100 also provides “help” explanations 350. This information will be shown to the user regarding this field when the user clicks “Help” on the menu while in the form pertaining to the INTAKE table.

It should also be noted that when the user edits the fields, the program instructs the computer to update the field lists at 58 of FIG. 4.

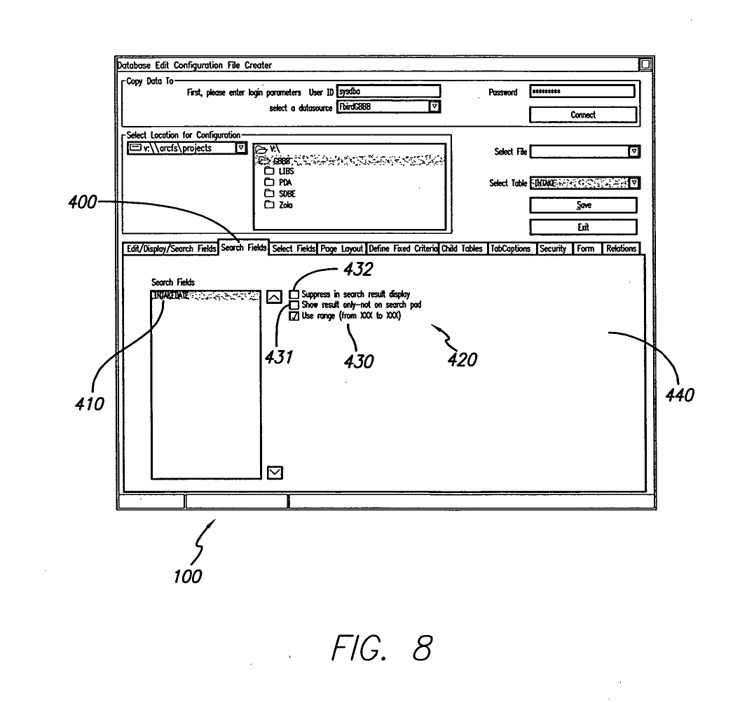

The next command 60 that the user may provide is to edit the search field information. In FIG. 8, the user selects the “Search Fields” tab 400 in interface 100. The selection of tab 400 provides a new lower portion 440 of the interface 100. The lower portion 440 identifies the field 410 to be further edited and provides options 420 to the user to define the search parameters. In the case of a date field, such as INTAKEDATE, the search parameters allow for a range to be entered. The user can search for events or the like occurring on a specified date, before a specified date or between two dates. For example, the user may want to allow searches requesting all intakes between Jun. 1, 2004 and Jun. 15, 2004. Such searches are provided by having the user select the “Use Range” checkbox 430.

It should be noted that the search is not limited to searching between two dates as described above. Either the first element (e.g., Jun. 1, 2004) or the second element (e.g., Jun. 15, 2004) can be left blank to have open-ended searches at one end. Moreover, the first and second element can be the same (e.g., to search for records having the date of Jun. 1, 2004). While the discussion of ranges has been in the context of date fields, any of the field types can be searched as a “range.”

Indeed, the user can describe all the available search parameters for each field through the configuration creation process. Text fields can be searched as is (“”), “ends with” (e.g., all records with last name ending in “B”), “includes” (e.g., all records with a “B” anywhere in the last name), “at least” (e.g., all records with a last name beginning in B through Z) and “not more than” (e.g., all records with a last name beginning in A through B). The user can select whether the search for text is case-sensitive or insensitive (currently, all searches of the present invention are employed as case-insensitive). Numeric, currency, or date-type fields can be by “at least”, “equals” or “not more than.” Other field types such as zip codes and telephone numbers are typically treated as text for searching, but can be configured to be numeric-type fields.

Referring back to FIG. 8, the other two options at 420 involve suppressing information. The “show result only” box 431, if checked, will display the INTAKEDATE field 410 in the select list resulting from the search, but not on the search page. The “suppress in search result” box 432, if checked, will display the INTAKEDATE field 410 on the search page, but not in the select list resulting from the search.

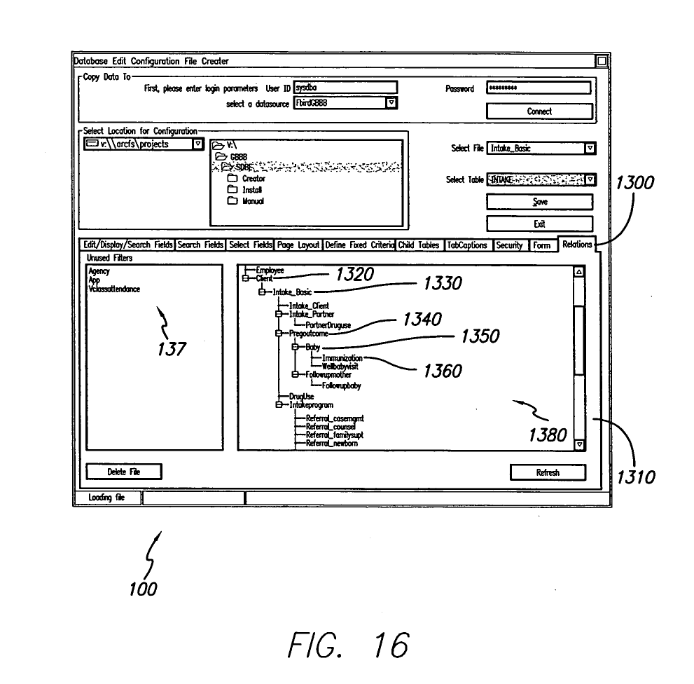

The next command 62 that the user may provide is to update or add select field parameters. If a given field is a “select field,” a drop-down list of values will be provided for selection by the user. There are at least three types of selection lists. The most common type of selection list is the direct list. In the direct list, a database table is used to populate the list. These tables are normally defined as a “List Box” discussed with respect to FIG. 15.

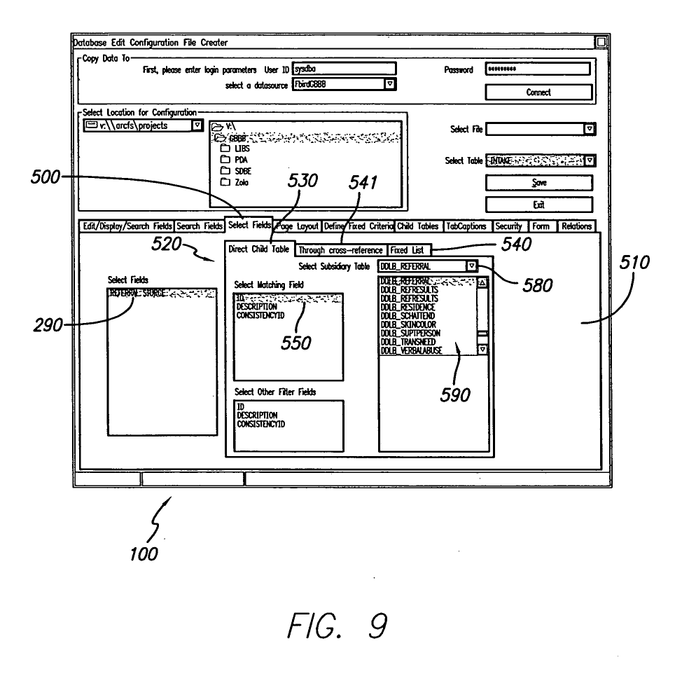

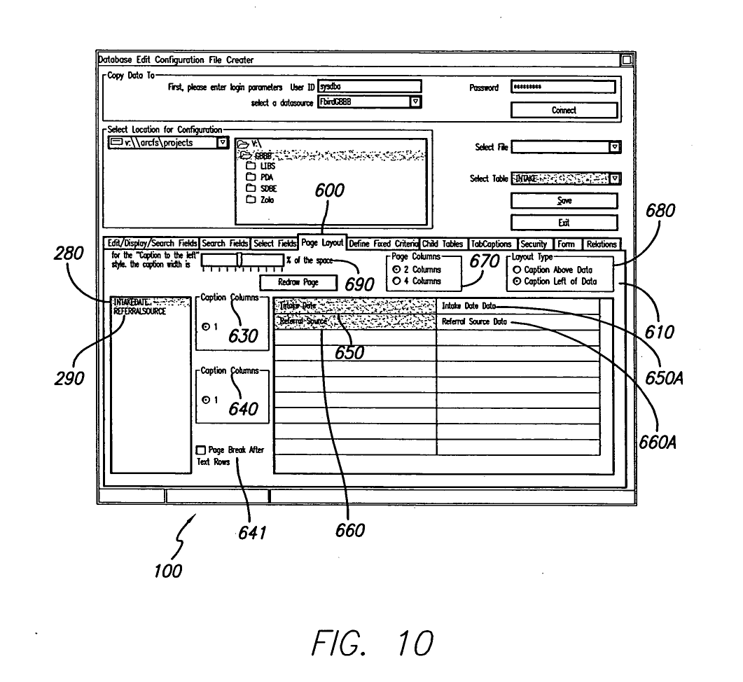

To create a direct list, the user selects the “Select Fields” tab 500 in interface 100 as illustrated in FIG. 9. The selection of the “Select Fields” tab 500 provides a new lower portion 510 of interface 100. In the illustrated example, the user has selected the REFERRALSOURCE field 290 for updating. The user clicks on the “Direct Child Table” tab 530 and selects a subsidiary table DDLBREFERRAL from a list of tables 590 provided by drop down list box 580. The table DDLB REFERRAL holds the values that will appear on the select list for the REFERRALSOURCE field 290. The user can also specify the matching field 550. The matching field is the field in the selected table (e.g., DDLB REFERRAL) that matches the selected database field (e.g., REFERRALSOURCE field 290).

Other data elements for the direct list include type, display fields and filter fields. With respect to type, the user determines whether to store the text value displayed on the screen into the database or store a number or ID that references the record in the selection list table. With respect to display fields, the user determines what fields are displayed to the user. Filter fields are fields that can be used to the limit the values displayed in the selection list.

A fixed list, rather than a direct list, is also available. By selecting the “Fixed List” tab 540, the user can limit the field values for the REFERRALSOURCE field 290 to certain defined values. For example, a fixed list would be used for a field relating to the gender of an individual. The data elements applicable to a fixed list include type (same as with a direct list), list of display values and, if applicable, list of values to be stored in a database.

Aside from a direct list and a fixed list, a cross-reference list is available. The user selects the “Through cross-reference” tab 541. This approach populates the list from a database table, but the user is able to select multiple entries on the list. The elements for a cross-reference list include type (same as with direct and fixed lists), cross-reference table name (i.e., the name of the table that stores the cross-reference information), cross-reference matching field (i.e., the field in the cross-reference table that matches the table currently being edited), cross-reference select field (i.e., the field in the cross-reference table that matches the table used to populate the selection list), select table name (i.e., the name of the table from which the select list will be populated), match field (same as with a direct list), display fields (same as with a direct list) and filter fields (same as with a direct list).

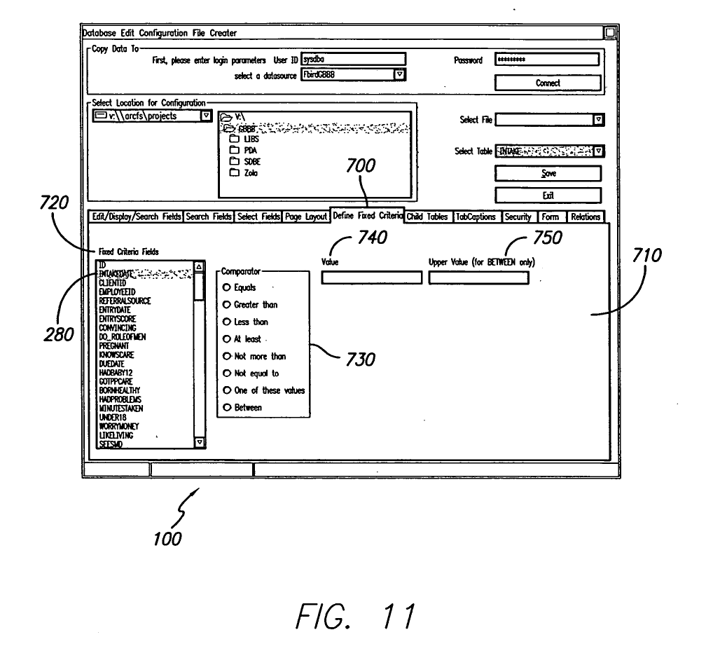

The next command 64 that the user may provide is to add or update the visual layout parameters. These parameters will define how a given interface for managing the data will appear on display 6A. The user selects the “Page Layout” tab 600 in interface 100 as illustrated in FIG. 10. The selection results in a new lower portion 610 of the interface 100. The upper section of the portion 610 provides various layout options. Page columns option 670 allows the user to define a two-column format for the form or a four-column format. Typically, a two-column format is utilized for a form with a small number of fields, while a four-column format is used for a form with a large number of fields.

The layout type option 680 allows the user to determine whether the captions will be to the left or above the data. The width option 690 allows the user to define more than one column in width for a long field and adjust how much width is reserved for the caption and how much width is reserved for the data entry. The left of the lower portion 610 displays the previously selected fields INTAKEDATE 280 and REFERRALSOURCE 290. The number of caption columns 630 is for giving a long caption more space, while the data columns 640 is for giving a long field more space. The “Page Break After Text Rows” box 641, if checked, forces the next field to start on a new line.

The user can also arrange the data rows. The data rows define the vertical space used by a specific field. If the field stores a first name or telephone number, the display requires only one line. For example, Intake Date 650 and Referral Source 660 are each placed on a single line. However, the user may need to include a data field with several paragraphs. The user in this case simply enters the number of rows for the field, and the displayed page will make the data entry block tall enough to hold the number of rows text needed.

The grid at 650 gives an approximate visual view of the layout. The user can see at 650 and 650A that the edit screen will comprise of two columns with the left and right columns of approximately equal width. The user can also see that the captions “Intake Date” and “Referral Source” will be displayed on the left and the intake data 650A and referral source data 660A will be displayed for editing on the right. Furthermore, the user will be able to see at 650 and 660 that the captions “Intake Date” and the “Referral Source” take one line each.

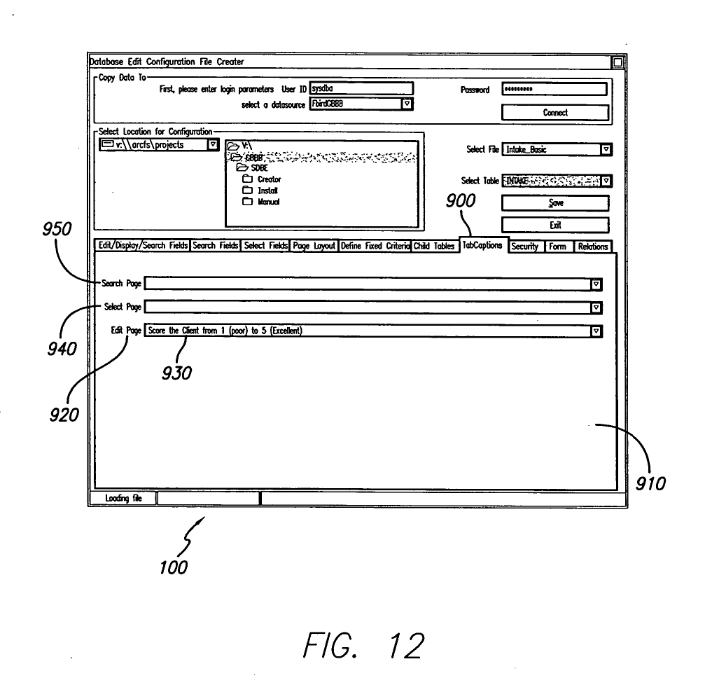

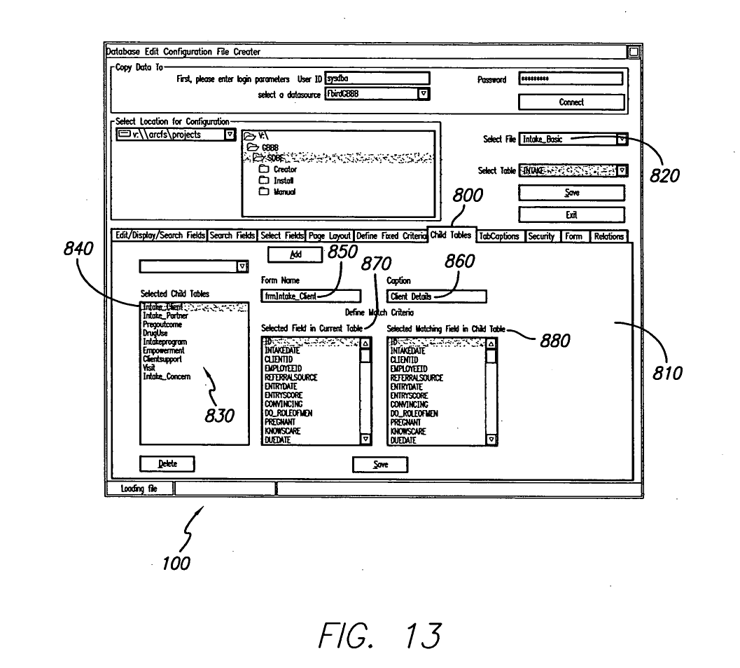

Two other commands relating to the page layout are illustrated in FIGS. 11 and 12. In FIG. I1, the user can select the “Define Fixed Criteria” tab 700 to place limits on what may be viewed or edited with the user interfaces for managing data. By selecting the “Define Fixed Criteria” tab 700, a new lower portion 710 of interface 100 in provided. The fields available for fixed criteria are listed in the left side of the lower portion 710 under a heading 720 entitled “Fixed-Criteria Fields.” In the illustrated example, the user has selected the INTAKEDATE field 280 for fixed criteria status. The various limits that may be placed on this field are set forth in boxes 730, 740 and 750. For example, the user may limit searching on the INTAKEDATE field 280 to every date “greater than” a specified date. It should be noted that for “not more than” a given value would include a inputted value that is equal to the given value. The “less than” would conversely exclude an inputted value that is equal to the given value.

FIG. 12 allows the user to place captions relating to the tabs on the user interface for managing data. If the user interface for managing data includes a form with three tabs for searching, selecting and edit (i.e., a search tab for a search page, a select tab for a select page and an edit tab for an edit page), the user can place captions at the top of each of the pages as desired. The user selects the “TabCaptions” tab 900 in the interface 100. This selection provides a lower portion 910 of interface 100. In the lower portion 910, the user can type captions for the search page 950, the select page 940 and the edit page 920. The illustrated example of FIG. 12 shows the user inputting a caption 930 for the edit page 920.

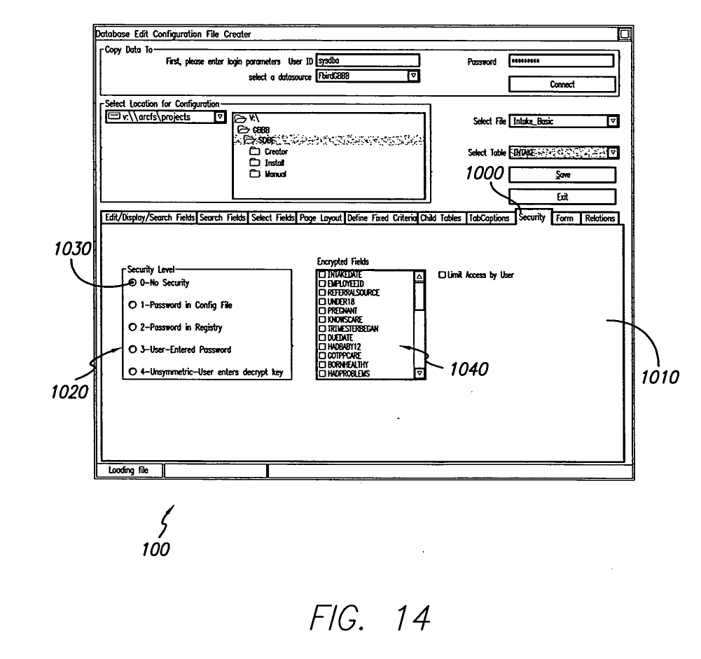

The next command 72 that a user may provide is to add or update “drill-down” child form parameters. “Drill-down” refers generally to viewing and editing subsidiary data. The user can create configuration data that will list the child tables pertaining to a selected table for the user to easily select if desired. To have this type of functionality, the user defines the form (e.g., “Intake_Basic” 820 in FIG. 13) and then selects the “Child Tables” tab 800 on interface 100. The selection provides a lower portion 810 of interface 100. At the left of the lower portion 810, there is list 830 of child tables. The user can select any of the listed tables to be a child table for the INTAKE table and its corresponding “Intake-_Basic” form.

In the illustrated example of FIG. 13, the user has selected the INTAKE_CLIENT table 840 as a child table. At 850, the user provides the name of the form corresponding to the INTAKE_CLIENT table that is used internally. At 860, the user provides the name of the caption to be displayed on the interface for managing data. The field selected from list 870 is the field in the current table that matches the child table. This is passed to the child form to limit the data to be displayed or entered. In other words, only the information in the child table that is relevant to the information selected in the parent table will be displayed. The field selected from list 880 is the field in the child table. This is to further ensure that data added to a field in the child table will be properly assigned to the corresponding field in the parent or master table.

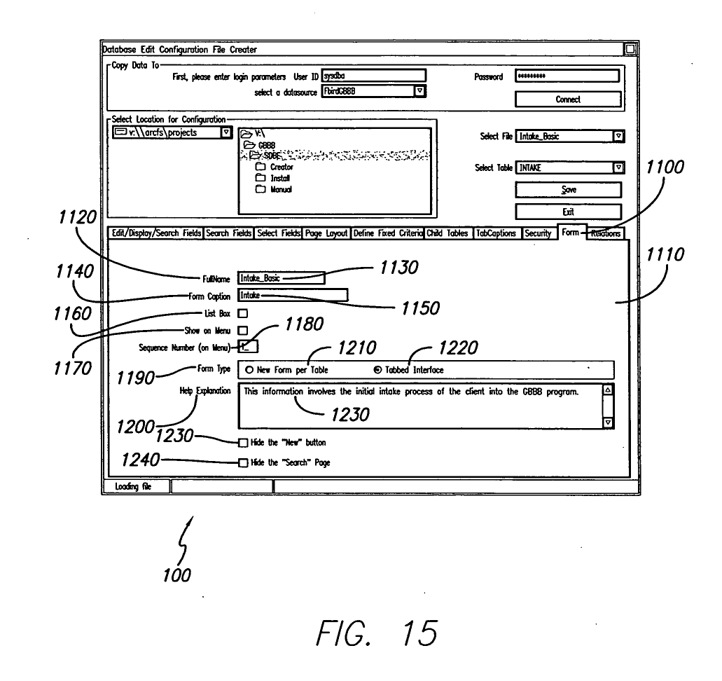

The next command 68 that a user may provide is to add or update encryption parameters. The encryption parameters allow certain fields in the database to be encrypted. Such encryption provides database security. Even if someone is able to gain unauthorized access to the database, he or she cannot view information for which they are not authorized (such as financial or medical information). To provide for database security, the user selects the “Security” tab 1000 as illustrated in FIG. 14. The selection provides a lower portion 1010 of interface 100. A security level box 1020 lists different levels of security, such as “0—No Security” 1030. The user chooses a field from list 1040 and then selects the security level.

The next command 70 that a user may provide is to add or update the form information. The form information relates to the information that will be displayed to the user on the interface for managing data. To set or update the form information, the user selects the “Form” tab 1100 as illustrated in FIG. 15. The selection provides a lower portion 1110 of interface 100 for setting or updating the form information. The lower portion comprises a variety of boxes and corresponding captions.

The “File Name” caption 1120 is to input the file name for the form to which the form information will apply. In the illustrated example of FIG. 15, the inputted file name is “Intake_Basic” 1130. The “Form Caption” 1120 allows the user to name the form, such as Intake 1150. The “List Box” check box 1160, if checked, indicates that the table corresponding to the form will be used to populate a drop down list on one or more data entry screens. All the tables that are checked as a “List Box” are shown for editing on separate window when the main application program is executed.

The “Show on Menu” check box 1170, if checked, will place the name of the form on the top menu of the user interface for managing data. The “Sequence Number” 1180 provides where the name of the form will appear on the menu.

The “Form Type” 1190 provides the user with a selection of the type of form. In this example, the user has two choices: either a new form per table 1210 (i.e., a form per window) or a tabbed interface 1220 (i.e., multiple tables in a tabbed display). FIG. 15 illustrates that the user has selected the tabbed interface form type 1220.

The “Help Explanation” box 1200 allows the user to place helpful explanations 1230 for the user or other users who may manage the same data. The explanations 1230 will appear on the form when generated.

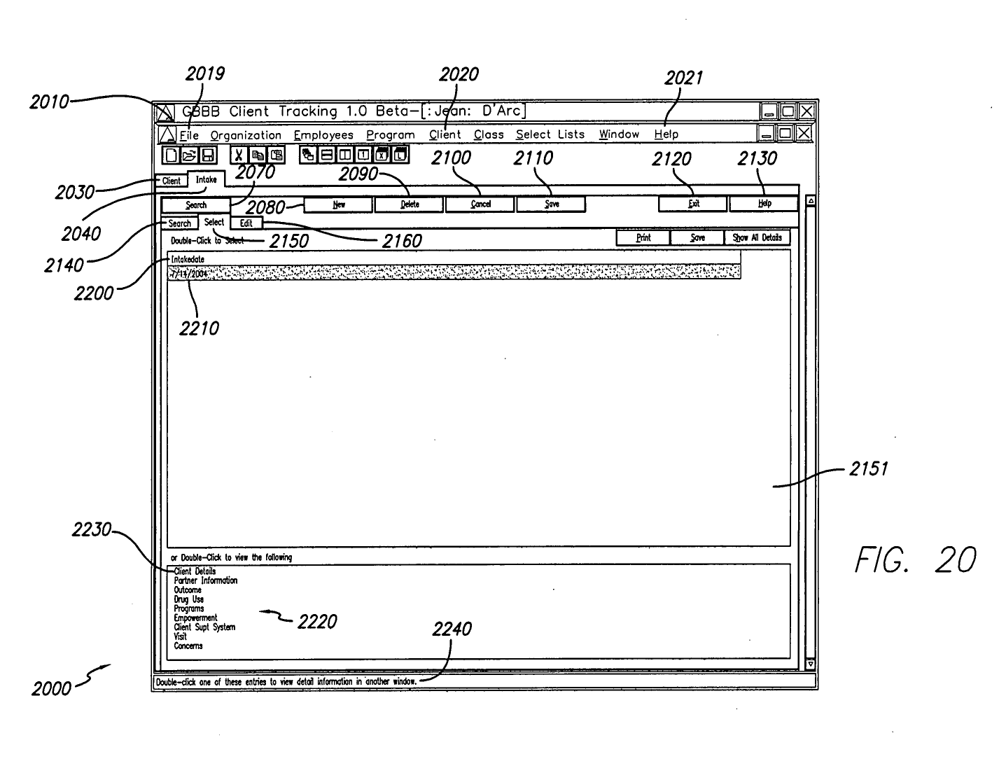

The “Hide the ‘New’ button” box 1230, if checked will hide the “New” button (e.g., button 2080 in FIG. 19). This prevents the user from creating a new entry. The “Hide the ‘Search’ page” box 1240, if checked, will begin the user interface display with the select list(s) already populated. When the number of select elements are known to be short, this speeds up the data entry process.

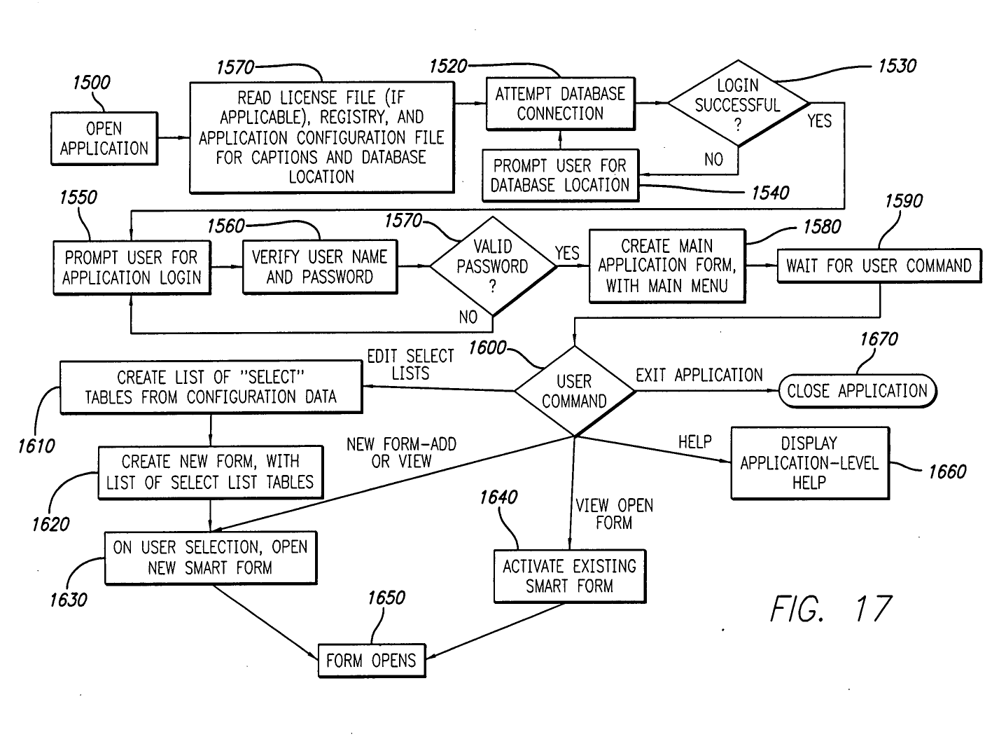

The user may at any time save the data that he has added or updated through the command at 74 of FIG. 4. Prior to saving, the user can select that “Relations” tab 1300 of interface 100 as illustrated in FIG. 16. By selecting the “Relations” tab 1300, the lower portion 1310 of the interface provides a list 137 on the left side of the lower portion 1310 that sets forth any forms that are currently not accessible. It should be noted that this illustrated example assumes that each configuration file relates to one form. Any of the forms listed as not accessible should be added to a parent, put on the menu, set as List Boxes or deleted.

The lower portion 1310 also includes a flow 1380 that gives a visual representation of how the data will be navigated. In the illustrated example, the “Client” form 1320 is on the menu. After selecting a client, the user can select the “Intake_Basic” form 1330. After selecting the “Intake_Basic” form 1330, the user can select the “PregOutcome” form 1340, then a “Baby” form 1350, then an “Immunization” form 1360 and so on.

The user will also be prompted to save data if he wishes to select a new table (illustrated at 66 in FIG. 4). If so, the entire process discussed above can be repeated. The user will also be prompted to save data when he closes the program at 76 to complete the configuration data creation 78.

C. Creating An Interface For Managing Data

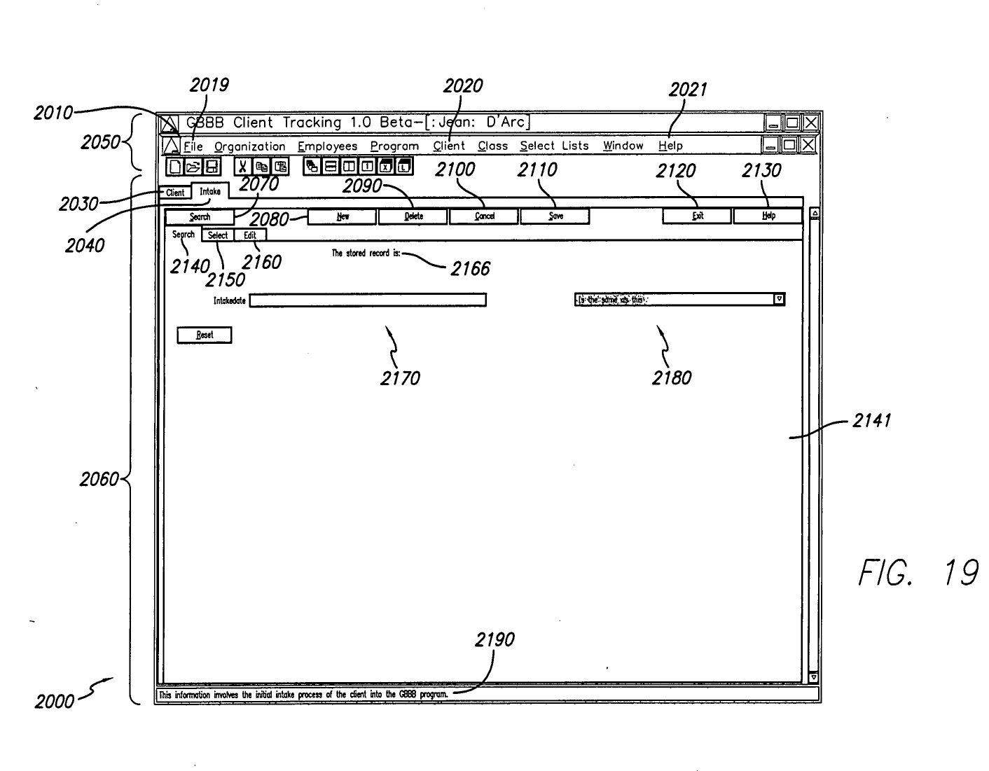

FIGS. 17 and 18 illustrate the steps or instructions of the main application program or end-user program. The application program utilizes the data in the database that may have been created at step 13 and the configuration data created at step 16 to generate user interfaces for managing data. Exemplary user interfaces are illustrated in FIGS. 19-22 and are discussed in conjunction with FIGS. 17 and 18. It should be noted that FIGS. 19-22 share some of the same elements and that some of these shared elements are not re-numbered in each of the figures.

Referring now to FIG. 17, the main application program can be opened at step 1500 by having the user select an icon of the program on display 6A. The program then instructs the computer at step 1510 to read the license file (if applicable), registry and application configuration file for captions and database location. At step 1520, the program instructs the computer to access the database. The sequence then proceeds to step 1530 where it is determined whether the login was successful. If is not, the user is prompted for the database location at step 1540. If the login is successful, the user is prompted for the application login information at step 1550. The user inputs the login information, and the program instructs the computer to verify the user name and password at step 1560. At step 1570, it is determined whether the password is valid. If it is not, the user is again prompted for the application login information. It should be noted that a login procedure is not required and that the sequence can proceed without the login procedures determined at 1530 and 1570.

If the password is valid, the sequence proceeds to create the main application form at step 1580. The main application form is displayed on display 6A. FIG. 19 illustrates a user interface 2000 generated by the program. At step 1580, the program generates only upper portion 2050 of the user interface 2000 with the lower portion 2060 left blank. The lower portion 2060 is generated later in the sequence. In the upper portion 2050, there is a main menu 2010 with different captions such as “File” 2019, “Client” 2020 and “Help” 2021. Some or all of the elements on the main menu may be based on the configuration data. As discussed above in conjunction with FIG. 15, during the configuration data creation process, the user may select “Form” tab 1100 to define elements of the form. One of the elements was a “Show on Menu” checkbox. If the user had selected this box for a given table, then the form caption corresponding to that table would appear on the menu 2010.

Once the main application form is displayed, the program awaits the user's instruction at step 1590. At this point, the user has many command choices as illustrated at 1600. The user, of course, may simply exit the application at 1670 at any time. The user may command the program to display the application-level help as illustrated at 1660. Selecting the “Help” caption 2021 in FIG. 19 will execute this command.

At 1610, the user may command the program to create a list of “Select” tables from the created configuration data. As discussed in conjunction with FIG. 9, certain fields may be configured to be “select-list” fields. Each of these fields will have an entry selected from a drop-down list by the user. The list is populated by a database table, and it can change over time. The user at 1610 of FIG. 17 commands the program to create a list of all “Select” tables. The program utilizes the configuration data to generate the list. Specifically, the program determines all the tables for which the user selected “ListBox” at 1160 of FIG. 15. Once the list of “Select” tables is generated, the user may proceed to create a new form displaying the list of “Select” tables at step 1620.

The user may then proceed to create a new interface form by selecting one of the listed tables at 1630. Alternatively, the user may directly activate an existing interface form at step 1640. For example, in FIG. 19, the user selected the “Client” caption 2020 on menu 2010. By making this selection, the user has indicated his desire to manage the database based on “Client”. The program proceeds to instruct the computer to open or generate a form corresponding to his selection as illustrated at 1650 in FIGS. 17 and 18. The interface form is generated as a portion of the current interface.

The form (entitled for the purposes of this application as a “smart form”) to be generated is a component. It comprises instructions for performing certain actions and provides a visual representation. The main application program needs to know nothing about the design or operation of the smart form. All that the main application does is to create the form component and tell the form what configuration file and database to use. Thereafter, as discussed below, the smart form generates itself.

The smart form is placed at the lower portion 2060 of FIG. 19. The smart form is based on a panel, which is simply a standard display element used for holding other more complex elements and may include other components for defining what is inside the panel. For example, the sub-components include a tabbed sheet component. This component essentially allows re-use of display space as illustrated with tabs 2140, 2150 and 2160. Inside the tab-sheet are three tab pages, i.e., SearchSheet, SelectSheet and EditSheet corresponding to sections 2141, 2151 and 2161 of FIGS. 19, 20 and 21 respectively. Other components are placed onto these pages.

FIG. 18 illustrates certain steps relating to the smart form. At step 1700, the main application program provides the configuration file name to the smart form. The configuration file is then opened at 1710 by the smart form. The configuration data in the file is used by the smart form to generate the tabs, buttons and captions of smart form component at 1720. For example, as illustrated in FIG. 19, search, select and edit are shown as tabbed interfaces 2140, 2150 and 2160 respectively. This configuration for the intake form was chosen by the user during the configuration data creation process. Specifically, the user selected the “Tabbed Interface” box 1220 in FIG. 15. In this manner, the configuration data established at step 16 of FIG. 2 is used to generate the user interface for managing data without the writing of any code.

Furthermore, some buttons are placed near or outside the top border of the tabbed Sheet component. For example, as illustrated in FIG. 19, these buttons include a “New” button 2080 for skipping the Search and Select steps and creating a new date entry space for edit, a “Delete” button 2090 for permanently removing the current record, a “Cancel” button 2100 for abandoning the edits, a “Save” button 2110 for recording any editing changes and an “Exit” button 2120 for exiting the program. These buttons are generated by the smart form, but their appearance can be modified by the user through the process of creating configuration data. While these are illustrated in FIG. 19 as buttons, they can tabs, images or some other display element.

At 1730, the program through the smart form instructs the computer to create the search components and arrange them on the search page. Once again, the smart form utilizes the configuration data generated at step 16 of FIG. 2 to create and arrange the components on the search page. For example, FIG. 19 illustrates a search page 2141 having a “Search” tab 2140. On the search page 2141, there is a box 2170 having a caption relating to intake date. As discussed in conjunction with FIG. 7, the INTAKEDATE field was defined as a search field (see 330 at FIG. 7) and; thus, now appears on the search page 2141. Moreover, the field was given a caption relating to intake date (see 300 at FIG. 7) and, thus, a caption relating to intake date appears by the box for the field.

As discussed with respect to FIG. 10, the user can select where the caption is to be placed in relation to the box and, in this case, the selection was left of the data (see 680 at FIG. 10). The explanation 2190 provided at the bottom of the search page 2141 was configured using the “Form” tab described in conjunction with FIG. 15 at 1200 and 1230.

In this manner, the program creates each of the search components based on the configuration data. This is done without the user writing any code.

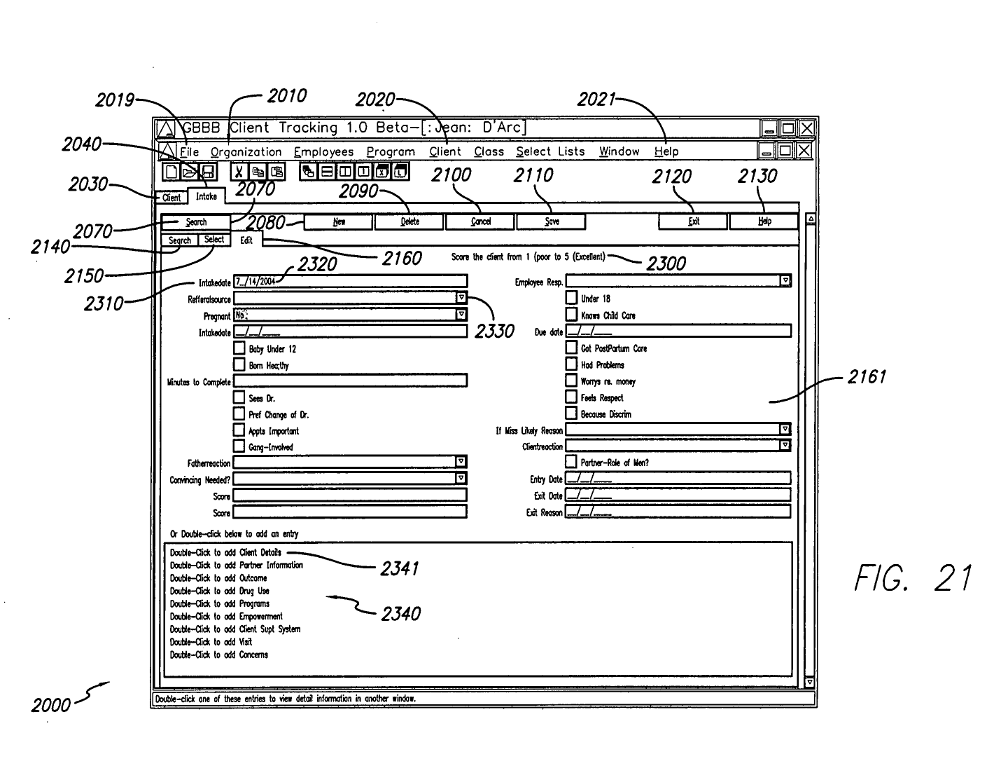

The program then proceeds at step 1740 to create the edit components on the edit page in the same manner as discussed above with respect to the components of the search page. FIG. 21 illustrates an edit page 2161 having an “Edit” tab 2160. The page 2161 includes a box bearing the caption relating to intake date 2310. This is generated using the configuration data described above with respect to the search page. Similarly, the box 2330 is a “select-list” field having a drop down list box. This box corresponds to the REFERRALSOURCE field selected in FIG. 7 at 290. The list to be dropped down will be populated by the DDLB REFERRAL table as discussed in conjunction with FIG. 9. FIG. 21 further illustrates a caption 2300 at the top of the edit page 2161. The program creates this caption based on the configuration data created by the user. Specifically, as discussed with respect to FIG. 12, the user utilized the “TabCaption” tab 900 to produce the caption on the edit page without writing any code.

FIG. 21 also illustrates a series of child tables 2340 that may be accessed by the user through the edit pages. These child tables were defined utilizing the “Child Tables” tab 800 during the configuration data creation process. As discussed with FIG. 13, the user selected the INTAKE_CLIENT table 840 to be a child table of the INTAKETABLE and named it with the caption “Client Details” 860. This relationship is then drill-downed when the edit page 2161 is created by displaying “Client Details” 2341 at the bottom of the page for access.

In this manner, the program through the smart form instructs the computer to create each of the edit components based on the configuration data without writing any code.

At 1750, the program through the smart form instructs the computer to set any special properties and resize the form. Special properties include special sized data fields or captions that are configured utilizing the “Page Layout” tab 600 of FIG. 10 and the caption and data columns boxes 630 and 640 therein.

The program then proceeds to step 1760 where, through the smart form, it instructs the computer to populate the select lists based on the configuration data and the database queries. For example, as discussed above, the edit page 2161 of FIG. 21 has a drop down list box 2330. The user selected the DDLB REFERRAL table at FIG. 9 to populate the list. At step 1760, the program instructs the computer to populate this list with the DDLB REFERRAL table and queries the database for the records of the table.

Once the select fields are populated, the program determines if the user is adding a new entry at step 1770. If the user is adding a new entry, the program sets an “append” flag and activates the edit page. For example, the user may want to add a new “intake.” The program sets the flag and activates edit page 2161 of FIG. 21. On that page the user can input the information for the new “intake” and save it using “Save” button 2110.

If the user is not adding a new entry, the program proceeds to step 1780 where it activates the search page, such as search page 2141 of FIG. 19. At this point, user interface 2000 is displaying the search page 2141, the edit page is hidden and the select page is inactive until a search query is submitted.

The program then awaits a command from the user. As illustrated in FIG. 18, the user has many command options. The user can select one option, perform several of the options independent or perform several of the options sequentially.

A command that the user may provide is to save data at step 1810 or exit the program. If the user exists the program, the program instructs the computer to prompt for save 1900. Prior to the form being closed at 1920, any child tables are closed for a tabbed form at 1910.

A command that the user may provide is to search the database at step 1820. To search the database, the user composes a database query. The database query is composed by entering information in a field. For example, in FIG. 19, the user can compose a database query by placing a date in the intake date box 2170. Then, the user executes the query by selecting button 2070. The program ensures that the query is appropriate by comparing the entry with the configuration data. For example, in FIG. 7, the INTAKEDATE field 280 was stored as a date field 340. If the user incorrectly places a letter in the query, the search will not be executed.

It should be noted that the user could have configured the field to be searched as a range as discussed with respect to FIG. 8. In 'the present invention the search screen, such as screen 2141 in FIG. 19, is sometimes not displayed to the user. For example, if the user determines that the maximum number of records is small, he can select the “Hide the ‘Search’ Page” box 1240 in FIG. 15. The main application program will hide the search page 2141, simulate a search by the user with no limits and proceed directly to the select page 2151 in FIG. 20.

When the search is executed, the program instructs the computer to provide a list of records that matches the search criteria. In the example of FIG. 19, the computer searches for any records in the INTAKE table that matches the data supplied in intake box 2170. The results of the search are then presented to the user through the user interface. In the example, the application opens the select page 2151 of user interface 2000. The select page 2151 may include many of the same elements in the search page 2141 depending on the configuration data (i.e., the select page is generated by configuration data in the same manner as the search page and the edit page discussed above). In FIG. 20, the search page 2151 includes the name 2200 of the field that was searched and one record 2210 that matched the search criteria.

The user can then select the record 2210 for editing by, for example, double clicking on the record or entry in the select page 2151 or selecting the edit tab 2160 to open the edit page 2161 of FIG. 21. This step corresponds to step 1840 of FIG. 18. FIG. 21 illustrates the intake date caption 2310 and the corresponding date 2320 selected in FIG. 20. At this stage, the user can review the displayed information, edit the information (in which case an updated flag is set), delete information and add information at step 1850 of FIG. 18. On the edit screen 2151, the user can select the “New” button 2080 to create a new record entirely. This action corresponds to step 1890 of FIG. 18. Once data for the new record is input, the program prompts for save and sets a “new record” flag.

The select page 2151 and the edit page 2161 each list subsidiary or child tables to the currently searched table. In the select page 2151, the subsidiary tables 2220 include “Client Details” 2230. Similarly, in the edit page 2161, the subsidiary tables 2340 include “Client Details” 2341. In both the select page 2151 and the edit page 2161, the user has the ability to select a subsidiary or child table such as “Client Details.” As illustrated in FIG. 18, whether the selection is made on the select page 2151 at step 1860 or on the edit page 2161 at 1870, the program creates a new smart form and sets properties (just as if the user had selected the “New” button 2080). The program instructs the computer to begin another Search-Select-Edit process for the selected child table.

It should be noted that at 1860 and 1870 the program can maintain the relationship on the previous page, i.e., the page or form relating to the intake date. Furthermore, if a search is executed on the new form relating to the subsidiary table, the computer will only display records which match the data selected on the previous page. Also, when creating a new record, the relationship to the data from the previous page is automatically recorded.

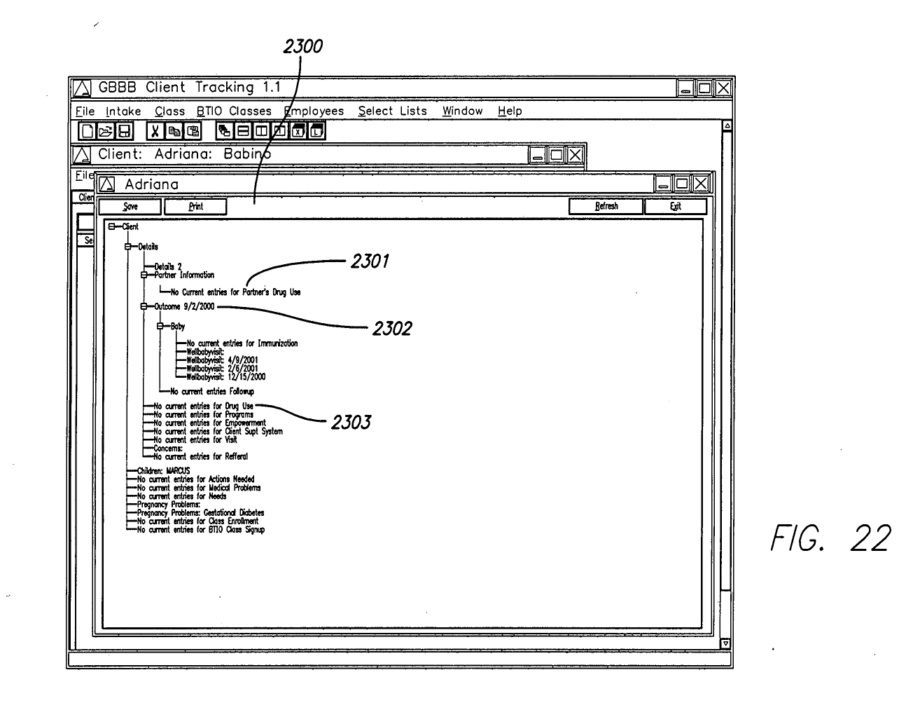

Another command that the user may choose is “Show all Details” at 1880 of FIG. 18. When this is selected (such as by clicking a button), the smart form directs the computer to successively read all the appropriate configuration files to create a new form displaying subordinate information. An example of such a form is illustrated in FIG. 22 as form 2300. The data displayed for the subordinate information can be the same information that would be displayed on the select page 2151. This form shows a summary of all the subsidiary information about the currently selected data record. As illustrated in FIG. 22, the user can quickly determine that the individual corresponding to the record does not have a drug dependency problem 2303, a partner with a drug dependency problem 2301 and that the pregnancy outcome (e.g, a birth) 2302 was on Sep. 2, 2000. This form 2300 can be used as a summary report, and can be printed or saved as a file. In addition, wherever data is displayed, the user can double-click on a record to bring up a smart form, allowing the user to rapidly find, view and edit information relating to a current entry.

While the present program can be used to manage data effectively, there are situations when a user may wish to provide added functionality to the program. The present invention allows the user to provide such added functionality with a minimum amount of code writing. The user, for example, can be a programmer with limited experience. This is achieved with the use of “methods” and “events”. Methods allow the programmer to introduce additional behavior beyond those in the any of the components discussed above (e.g., smart form, edit sheet, etc.). The methods are commands from the main application program to the smart form component. For example, methods in the smart form component include “SaveButtonClick” saves a record or “SetCaption” sets the caption for a specific edit field. Events are what the components do, such as “OnSaveClick” occurring when the user saves the record utilizing the smart form component.

Some of the “methods” and “events” of the present invention include the following:

(1) Method NewDBE which creates a new child smart form component, and if necessary creates the form in which it resides. It automatically maintains the information on the connection between the originating form and the newly created form.

(2) Methods ClearFixedFields, AddFixedField, GetFixedValue, ClearFixedValue. Fixed fields hold data that is constant for a given form. An example of a fixed field would be: for a form that shows a list of tax returns, the social security number of each taxpayer to whom it belongs would be a fixed field. These methods allow the program to read or manipulate this information.

(3) Methods AddSelectField, ClearSelectFields. These allow the developer to set fields to be used in conjunction with the configuration file to limit the values displayed in a selection list.

(4) Methods GetFieldVal, SetFieldVal. These allow setting or reading the current value, after any editing, of specific fields.

(5) Events OnNeedDBE, OnNeedNewForm occur when the smart form needs to create a new drilldown child edit screen. For those tables the user or programmer creates a copy of the standard smart form and adds whatever features are necessary. The user or programmer adds a few lines of code to tell the main program, when creating a new smart form, to see if it should use the special form. If not, it will automatically create the standard form

(6) Events OnDataChanged occurs when the user changes data. This is used when the application needs to take some special action based on the value of specific fields in the database.

(7) Events Select page OnGridClick, SelectSheet OnGridDblClick. These occur when the user selects a record for viewing or editing. This event is commonly used in conjunction with the various FieldVal, Fixed Field, and Select Field methods to set display parameters. For example, in these events, the application might read the “Pregnant” field from the current record. Based on whether the current client was or was not pregnant, it could set a specific “Fixed Field” value. Setting this value would limit the list of services displayed on the edit page so that, for example, contraception or prenatal providers would be displayed as appropriate.

In each case, all the other capabilities of the component function as designed and without additional programming. Only some small amount of additional functionality is provided, and that requires only a few lines of software coding. In this manner, the application can easily implement operational business rules as discussed above with respect to “business rules.”

One example where “methods” and “events” can be used to add functionality is when a database rule cannot be easily implemented. For example, in the organization discussed above, there may be a desire to only allow managerial staff to enter a pregnancy due date. This is not an easily implemented database rule. There is an event entitled “OnDataChanged” which is called by the program whenever the user changes information. The user can prepare a short subroutine called an “event handler” for the OnDataChanged event. The subroutine would check to see if the changed data was the due date field. If the changed data was the due date field, the subroutine can further determine whether the user is a manager or administrator. If he is, the “Save” button 2110 is enabled. If he is not, the “Save” button is disabled. Because this is all the code that the user needs to prepare, the present invention can easily add advanced functionality to the program. Furthermore, such functionality can be added very late in the design process after the client has reviewed, approved or tested the application.

Although the present invention has been fully described in connection with the embodiments thereof and with reference to the accompanying drawings, it is to be noted that various changes and modifications will become apparent to those skilled in the art. Such changes and modifications are to be understood as being included within the scope of the present invention as defined by the claims.

What is claimed is:

1. A method for managing data, said method comprising:
creating a database comprising a plurality of tables, each table comprising a plurality of records having fields for storing data;
creating configuration data for at least one table; and
generating, based on the configuration data, at least one user interface to search, select or edit the plurality of records of the table.

2. The method of claim 1 wherein generating at least one user interface comprises generating a search page, a select page and a edit page.

3. The method of claim 2 further comprising:
using at least one of the search page, the select page or the edit page to search, select or edit the plurality of records of the table.

4. The method of claim 3 wherein using at least one of the search page, the select page or the edit page comprises using the edit page to select a child table related to the table.

5. The method of claim 1 wherein creating configuration data comprises
generating a plurality of interfaces;
selecting at least one interface; and
setting at least one parameter on the selected interface.

6. The method of claim 5 wherein the at least one parameter relates to selecting a field to be searched by the user interface.

7. The method of claim 5 wherein the at least one parameter relates to selecting a field to be populated by a list.

8. The method of claim 5 wherein the at least one parameter relates to defining a form of the user interface.

9. The method of claim 5 wherein the as least one parameter relates to establishing a relationship between the table and at least one child table.

10. A medium containing instructions to cause an apparatus to implement a method for managing data, said method comprising:
creating a database comprising a plurality of tables, each table comprising a plurality of records having fields for storing data;
creating configuration data for at least one table; and
generating, based on the configuration data, a user interface to search, select or edit the plurality of records of the table.
